(19) United States
(12) Patent Application Publication
(10) Pub. No.: US 2005/0128059 A1
(43) Pub. Date: Jun. 16, 2005

(54) Apparatus method and system for docking a trailer to a towing vehicle

(76) Inventor: Douglas Vause, Farr West, UT (US)

Correspondence Address: KUNZLER & ASSOCIATES, 8 EAST BROADWAY, SALT LAKE CITY, UT, 84111, US

(21) Appl. No.: 10/737,661

(22) Filed: Dec. 16, 2003

(51) Int. Cl. G08B 21/00

(52) U.S. Cl. 340/431; 340/435; 340/686.2

(57) ABSTRACT

A system for docking a vehicle to a trailer includes a scanning module affixed to the rear of a vehicle that scans the area behind the vehicle to locate and measure the distance to a trailer, utilizing a reflector affixed to the trailer. A display module in the cab of the vehicle receives distance and direction data from the scanning module and uses a graphical display to graphically depict the distance and relative orientation between the vehicle and trailer. In one embodiment the graphical depiction is an overhead view with an icon indicating the position of the trailer hitch. The present invention enables an unassisted vehicle operator to align and position a vehicle for docking with a trailer.

### BACKGROUND OF THE INVENTION

1. Field of the Invention

The present invention relates to docking a trailer to a towing vehicle. Specifically, the invention relates to apparatus, methods, and systems for aligning a vehicle to a trailer for docking.

2. Description of the Related Art

When backing a vehicle up to attach a trailer, the vehicle operator faces a number of simultaneous challenges. First, steering a vehicle while backing up can be difficult even for experienced drivers. Second, judging a vehicle's position relative to the trailer, vehicle speed, and direction can be confusing when using mirrors or when turned to face the rear of the vehicle. Finally, the area immediately behind the vehicle is typically not visible to the driver, particularly when the vehicle is close enough to the trailer for docking and connectivity to occur.

The most common method of coping with the challenges of orienting a vehicle to a trailer is to have an assistant stand behind the vehicle and use signals indicating distance and direction to guide the vehicle operator. Unfortunately, an assistant in not always available when a vehicle operator needs to back a vehicle to attach a trailer. Even when an to assistant is available, it can be difficult to communicate the distance and direction the vehicle operator must move.

Accordingly, a need exists for an apparatus, method, and system for orienting a vehicle to a trailer that assists the operator by scanning the area behind the vehicle to determine the orientation and distance to a trailer and graphically displaying trailer orientation and distance information to the vehicle operator.

### BRIEF SUMMARY OF THE INVENTION

The present invention has been developed in response to the present state of the art, and in particular, in response to the problems and needs in the art that have not yet been fully solved by currently available vehicle docking systems. Accordingly, the present invention has been developed to provide an apparatus, method, and system for vehicle docking that overcome many or all of the shortcomings in the art.

The present invention provides a technological solution to the problem of orienting a vehicle to a trailer through the use of an energy wave or one or more energy beams such as laser, sonar, or microwave, to determine the direction and location of the trailer behind the vehicle and measure the distance between the vehicle and the trailer. A reflector and/or transponder device is attached to the trailer, and the energy wave or beam is used to scan the area behind the vehicle to determine the location and orientation of the trailer. A graphical display depicts the position of the trailer relative to the vehicle.

In one aspect of the present invention, an apparatus for orienting a vehicle to a trailer includes a scanning module that scans a region behind a vehicle. The region may be horizontally and/or vertically scanned and may be scanned with a focused (i.e. substantially parallel) beam or group of beams. The scanning module may include a detector that receives energy reflected from a reflector or transponder device affixed to a trailer. Alternately, the energy receiving detector may be physically separate from the scanning module.

The scanning energy may be laser energy, sonar energy, microwave energy, or the like. The energy may be emitted continuously or intermittently, and may be configured to enable measurement of the distance between the vehicle and the trailer, and the orientation of the trailer relative to the vehicle. When scanning the area behind the vehicle, the scanning module may use a scanning pattern to facilitate efficient location of the trailer. Suitable scanning patterns include a raster pattern, a circular spiral pattern, a box spiral pattern, and a zamboni pattern.

The reflector may be concave, flat, or convex, and may include a number of facets to enable reflection from a variety of angles. In addition, the reflector may have a pattern encoded on the surface to facilitate measuring the location and orientation of the reflector. Useful patterns include concentric circles, concentric diamonds, a diamond checkerboard, a rectangular checkerboard, a bar code pattern, a circular bar code pattern, or the like. In one embodiment, the reflector is reflective tape attached to a suitable surface on the trailer.

A graphical display resides within a vehicle cab and visually displays a relative trailer position to an operator. The graphical display may be equipped with an acoustic transducer such as a speaker that provides distance information in audible form. The graphical display may use any type of two-dimensional graphical display such as a CRT display, an LCD display, a plasma display, or a field emission display in order to display the orientation and distance from the vehicle to the trailer, to the vehicle operator.

In certain embodiments, an overhead view of the trailer and vehicle, or portions thereof, are depicted on the graphical display. By combining a scanning module and reflector that determine the orientation and distance between the vehicle and trailer, with a graphical display that graphically represents that information to the operator in a user-friendly manner, a technological system for docking a vehicle to a trailer duplicates and improves upon the functions of a human assistant.

In another aspect of the present invention, a method for orienting a vehicle to a trailer includes scanning a region behind a vehicle, receiving energy reflected from a reflector affixed to a trailer, and displaying location and/or orientation information to an operator regarding the relative position of the trailer.

In certain embodiments of the present invention, the method for scanning the region behind the vehicle involves intermittently emitting scanning energy. The method may also include measuring a reflection distance or angle. In some embodiments, displaying the relative position of the vehicle and trailer to an operator may include displaying a scaled representation of the vehicle and the trailer that communicates distance and orientation information in graphical form. Angle and distance information may be overlaid over the graphical depiction to provide precise distance and orientation information such as the angle of the trailer relative to the vehicle.

Various elements of the present invention are combined into a system for orienting a vehicle to a trailer. In one embodiment, the system for orienting a vehicle to a trailer includes a vehicle, a trailer, a scanning module that scans the region behind the vehicle, a detector that receives energy reflected from a reflector affixed to the trailer, a reflector affixed to the trailer that reflects a scanning wave or beam, and a graphical display that resides within the vehicle cab and graphically depicts the relative trailer position to an operator.

A scanning pattern may be used to scan the region behind the vehicle. Scanning the area behind the vehicle with a scanning pattern facilitates locating the trailer regardless of the height of the trailer or the unevenness of the terrain. Additionally, the scanning module and the reflector may be the only system components required to be attached to the outside of the vehicle and trailer, and no complex procedures for focusing or calibrating the vehicle docking system are required.

The graphical display resides in the cab of the vehicle, visible to the vehicle operator. The graphical display utilized by the system for orienting a vehicle to a trailer may include a CRT display, an LCD display, a plasma display, a field emission display, or the like. The graphical display graphically depicts the direction and distance the vehicle operator must back the vehicle to position it for docking with the trailer. As the vehicle is moved into position, the display updates to enable the operator to steer the vehicle into the proper alignment with the trailer. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting one embodiment of a vehicle docking system in accordance with the present invention;

FIG. 2 is a block diagram depicting various embodiments of scanning modules in accordance with the present invention;

FIG. 3 is a block diagram depicting one embodiment of a graphical display in accordance with the present invention;

FIG. 4 is a block diagram depicting reflector patterns that may be used in a vehicle docking system in accordance with the present invention;

FIG. 5 is a block diagram depicting scanning patterns that may be used in embodiments of a vehicle docking system in accordance with the present invention;

FIG. 6 is a flow chart diagram illustrating one embodiment of a trailer position display method of the present invention; and

FIG. 7 is a flow chart diagram illustrating one embodiment of a trailer position scanning method of the present invention.

### DETAILED DESCRIPTION OF THE INVENTION

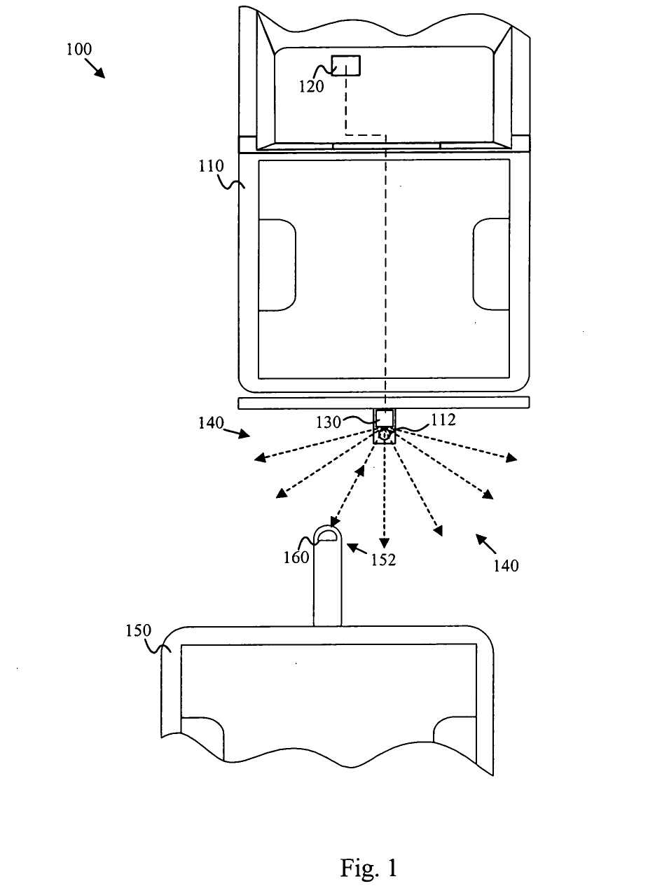

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 6, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments.

FIG. 1 is a block diagram illustrating one embodiment of a vehicle docking system 100. The vehicle docking system 100 includes a vehicle 110, a vehicle hitch 112, a graphical display 120, a scanning module 130, an energy wave or beam 140, a trailer 150, a trailer hitch 152, and a reflector 160. The vehicle docking system 100 enables a vehicle operator to dock a trailer to a vehicle without additional human assistance.

In the depicted embodiment, the scanning module 130 sits above the vehicle hitch 112 to facilitate scanning. The scanning module 130 scans the region behind the vehicle 110 by generating an energy wave or beam 140 directed to the area behind the vehicle 110, and receiving energy reflected by the reflector 160. The energy wave or beam 140 may be directed in a scanning pattern that facilitates detection of the angle of the trailer to the scanning module. Once collected, the scanning module 130 provides scanning data to the graphical display 120 or control module associated therewith (not shown).

The energy wave or beam 140 may be electromagnetic energy, sonar energy, or the like. The reflector 160 may take any geometric shape, and may have a convex, flat, or concave reflective surface. The reflective surface of the reflector 160 may be smooth or may if include facets configured to reflect the energy wave or beam 140 back to the scanning module 130. The reflector 160 is preferably mounted in a known location relative to the trailer hitch 152 to facilitate precise detection of the position of the trailer hitch 152.

In the depicted embodiment, the reflector 160 is a convex reflector. While the reflector may be as simple as a piece of reflective tape, in some embodiments, the reflector 160 may have a reflection pattern encoded thereon such as a pattern of concentric circles, a diamond pattern, a checkerboard pattern, a bar code pattern, a circular bar code pattern, or the like. The pattern reflected by the reflector 160 may facilitate detection of the orientation of the trailer or provide additional information about the trailer 150, such as a tracking identifier or a description of the payload.

In another embodiment, the reflector may consist of a transponder unit that detects the energy beam emitted by the scanning module and emits a distinct energy response, such as a electromagnetic energy, sonar energy, or the like. To facilitate location of the trailer, the response emitted by the transponder may be proportional to the strength of the energy beam received.

The graphical display 120 graphically depicts the position of the trailer hitch 152 relative to the vehicle hitch 112 and may depict the orientation of the trailer 150. The process of scanning and displaying position and orientation information occurs continuously as the vehicle 110 moves into position for attachment to the trailer 150. In certain embodiments, obstructions (not shown) are also detected by the scanning module 130 and are depicted on the graphical display 120. In such a manner, the vehicle docking system 100 enables a vehicle operator to dock a trailer to a vehicle in a safe convenient manner.

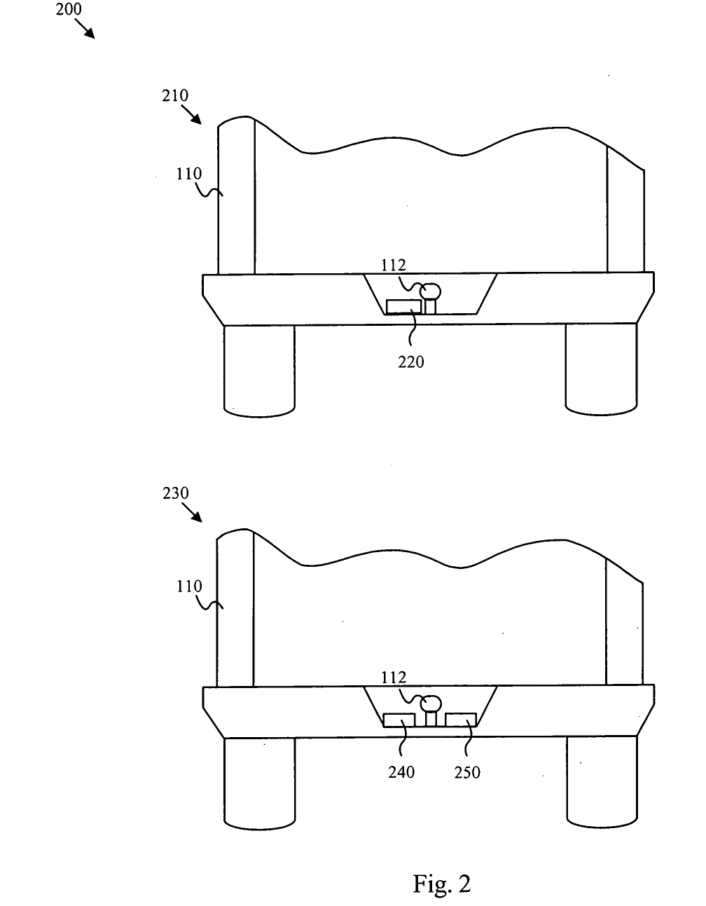

FIG. 2 is a block diagram depicting two embodiments of scanning arrangements 200 related to the scanning module 130 of FIG. 1. A first scanning arrangement 200a includes an integrated scanning module 130 that both emits the energy wave or beam 140 and detects energy reflected from a reflector. A second scanning arrangement 200b includes separate submodules 130a and 130b that function separately to emit the energy wave or beam 140 detects and detect energy reflected from a reflector. In both depicted arrangements, the scanning modules 130 are mounted at the rear of the'vehicle 110, near the vehicle hitch 112. Other embodiments and arrangements of the scanning module 130 (not shown) may accommodate manufacturing constraints or advantages, or technological advantages. For example, the scanning module 130 may be incorporated into a vehicle bumper to physically protect the scanning module 130 from impact by rocks or other road hazards.

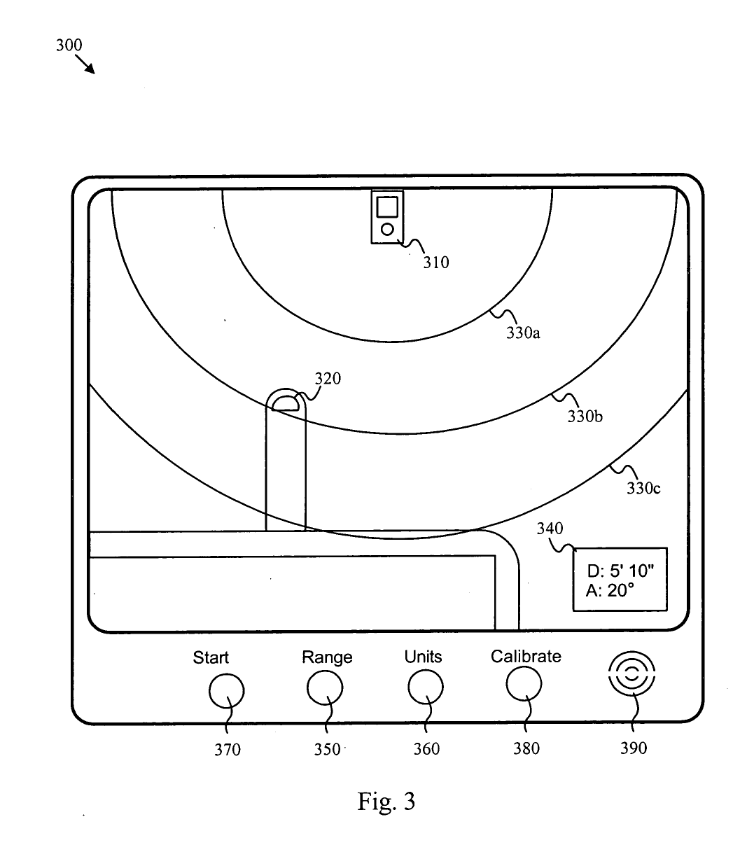

FIG. 3 is a block diagram depicting one embodiment of a graphical display 300. The depicted graphical display 300 includes a vehicle hitch position indicator 310, a trailer hitch position indicator 320, distance indicators 330a, 330b, and 330c, a position read-out 340, a range control 350, a units control 360, a start control 370, a calibrate control 380, and an acoustic transducer 390. The depicted graphical display 300 is one example of the graphical display 120 and may be used to depict an overhead view of the relative positions of the vehicle 110 and trailer 150.

In the depicted embodiment, the vehicle position indicator 310 is at the top center of the graphical display 300. The graphical display 120 displays the trailer hitch position indicator 320 on the graphical display 300 at a point representing the position of the trailer relative to the vehicle. The trailer hitch position indicator 320 may be a dot, icon, or similar graphical figure. The trailer hitch position indicator 320 may also communicate the orientation of the trailer hitch 152 and the trailer 150.

The distance indicators 330 approximate the distance between the vehicle hitch and the trailer hitch. The distance indicators may be fixed indicators such as a series of rings printed or etched on the face of the graphical display 120, or dynamic indicators that are continuously rendered on the graphical display 120. In some embodiments, the distance indicators 330 may indicate distance information in English and/or metric units.

The position read-out 340 provides the distance and direction of the trailer in textual form corresponding to the information displayed graphically by the vehicle position indicator 310, the trailer hitch position indictor 320, and the distance indicators 330. The position read-out 340 may indicate distance in English and/or metric units. The position read-out 340 may be oriented with 0 degrees or 180 degrees directly behind the vehicle. The position read-out 340 may use various ranges including, for example, 90 to 270 degrees, or −90 to +90 degrees. In one embodiment, the range of angles displayed is user-configurable.

The range control 350 selects the distance range displayed by the graphical display 120, such as 3, 10, and 30 feet, or 1, 3, and 10 meters. The units control 360 controls whether the distance indicators 330 and the position read-out 340 use English or metric units. In one embodiment, the range control 350 and units control 360 are a single range/units button that sequences through both metric and English ranges, such as 3 feet, 10 feet, 30 feet, 1 meter, 3 meters, 10 meters. The start control 370 may be used to initiate operation of the system. In another embodiment, and on/off control is used in place of a start control. The calibrate control 380 may be used to initiate a calibration sequence.

The acoustic transducer 390 may be included in certain embodiments of the graphical display 300 in order to provide distance information in audible form. For example, in one embodiment a tone is generated via the acoustic transducer 390. The tone may be proportional or inversely proportional to the distance between the vehicle 110 and the trailer hitch 152. In another embodiment, temporal spacing between distinctive sounds such as chirps or clicks is varied as a function of the distance between the vehicle 110 and the trailer hitch 152. Providing distance information in audible form may improve the trailer docking experience for the operator.

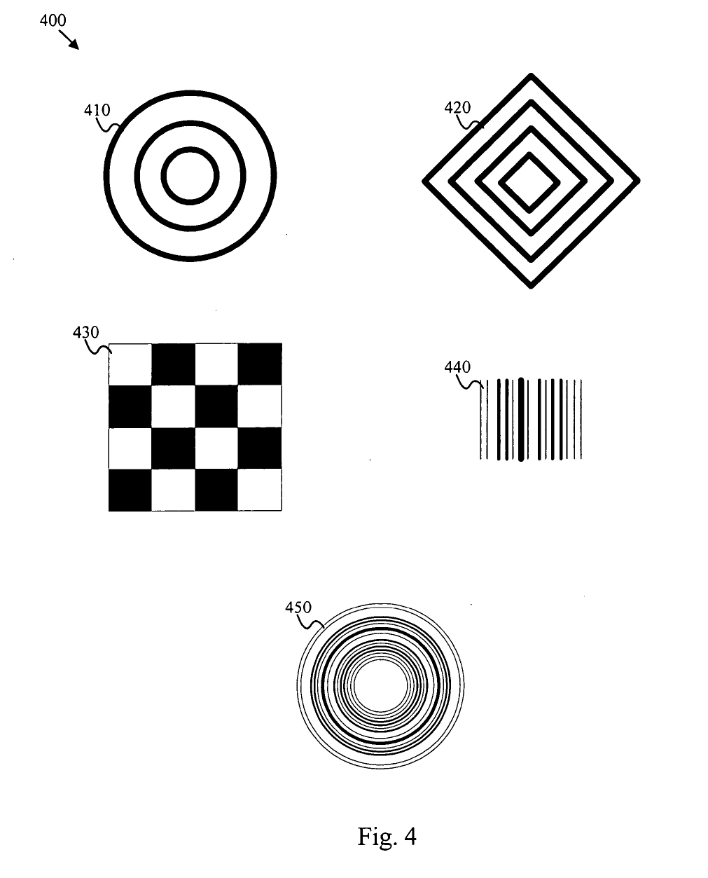

FIG. 4 is a block diagram depicting reflector patterns 400 that may be used in accordance with the reflector 160 of FIG. 1. The depicted reflector patterns 400 include a concentric circle pattern 410, a concentric diamond pattern 420, a checkerboard pattern 430, a bar code 440, and a circular bar code 450. The reflector patterns 400 enable the scanning module 130 to differentiate between energy reflections received from the reflector 130 and reflections received from other reflective surfaces that may be in the vicinity.

Certain reflector patterns in combination with particular surface shapes upon which the reflector pattern is encoded, may facilitate detection of the orientation of the trailer. For example a symmetric repetitive pattern such as the concentric circle pattern 410, concentric diamond pattern 420, checkerboard pattern 430, or circular bar code 450, may provide orientation information when encoded on a convex or concave surface. For example, the relative spacing the concentric circles 410 are maximized at a point where a scanning beam is perpendicular to the surface. With a concave or convex surface, the location of maximum spacing within the target pattern may be detected to derive the relative orientations of the vehicle and trailer. In addition to orientation information, some reflector patterns such as the bar code 440 and circular bar code 450 may provide additional information about the trailer 150 such as a tracking identifier or a description of the payload.

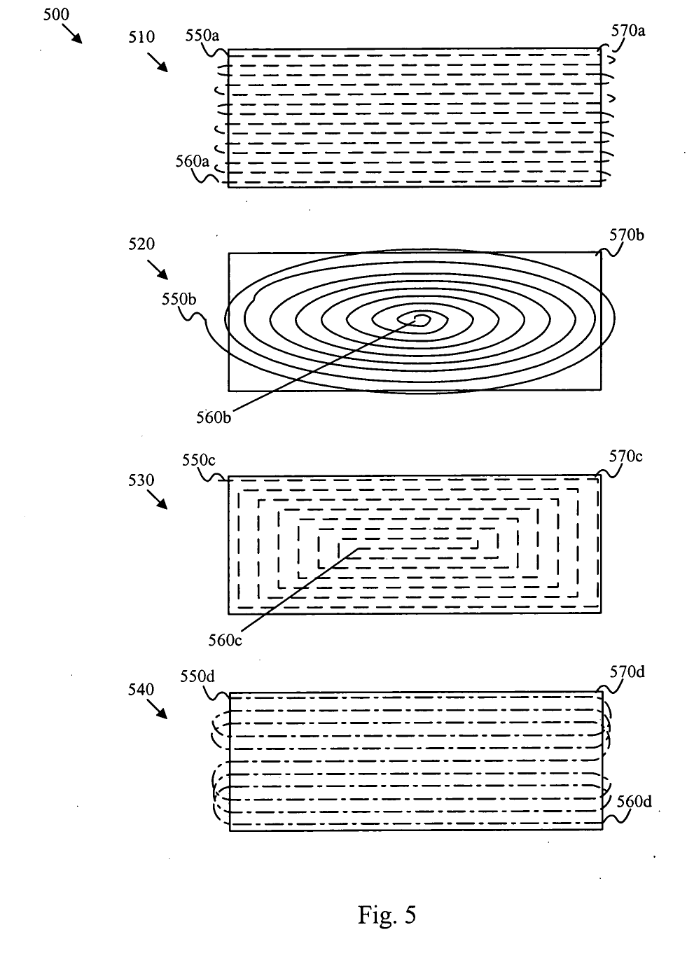

FIG. 5 is a block diagram depicting various scanning patterns 500 that may be used by the scanning module 130 of FIG. 1. The scanning patterns 500 include a raster pattern 510, a circular spiral pattern 520, a box spiral pattern 530, and a zamboni pattern 540. The scanning patterns have begin points 550a, 550b, 550c, and 550d, and respective end points 560a, 560b, 560c, and 560d within the respective scanning areas 570a, 570b, 570cand 570d.

Due to the variation in the height of trailer hitches and variation in terrain, the scanning module 130 may scan in two dimensions to facilitate locating a trailer behind a vehicle. The depicted scanning patterns accommodate a fairly wide variation in hitch height and terrain slope and have a scanning window with a both horizontal aperture and vertical aperture.

Scanning patterns vary in their efficiency in locating a target, but the choice of a scanning pattern may depend on mechanical limitations of the scanning module 130. For example, mechanical limitations on the scanning module may prevent successive sweeps with overlapping coverage. Other factors that affect the efficiency of the scanning pattern are the size of the reflector 160, and width of the energy wave or beam 140.

In each of the depicted embodiments of scanning patterns, scanning begins at the begin point 550 at the upper left corner of the scanning area 570 and proceeds to the end point 560. In other embodiments of scanning patterns, the begin point 550 may be at other corners of the scanning area 570. In the circular spiral scanning pattern 520 and the box spiral pattern 530, the begin point 550 may be at the center of the scanning area 570.

In the depicted raster scanning pattern 510, scanning proceeds in a horizontal back-and-forth pattern across and down the scanning area 570a. In other embodiments of the raster scanning pattern 510, the scan may proceed vertically within the scanning area 570a. In the depicted elliptical spiral scanning pattern 520, scanning proceeds in an elliptical spiraling motion within the scanning area 570b until the end point 560b at the center of the scanning area 570b is reached. In the depicted box spiral pattern 530, scanning proceeds in a rectangular pattern into the scanning area 570c until the end point 570b at the center of the scanning area 570c is reached.

In the depicted zamboni pattern 540, scanning proceeds left-to-right across the scanning area 570d, moves downward within the scanning area 570d for the return right-to-left scan, then'moves upward to scan a portion of the area skipped by the previous downward motion. This pattern continues until all the scanning area 570d has been scanned. The zamboni pattern 540 is typically used when the scanning module 130 has a turning radius greater than the width of the energy beam.

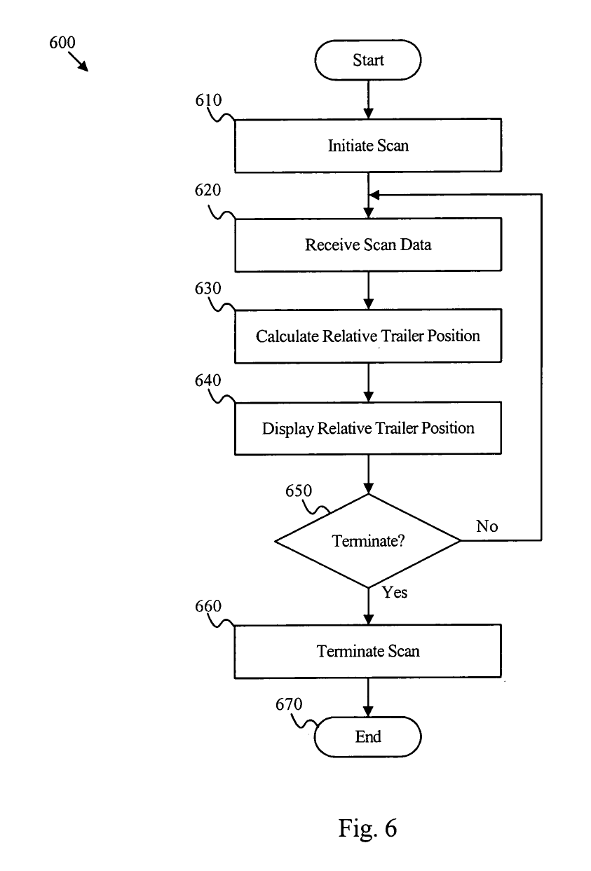

FIG. 6 is a flow chart diagram illustrating a trailer orientation display method 600 of the present invention. The trailer orientation display method 600 includes an initiate scan step 610, a receive data step 620, a calculate position step 630, a display position step 640, a terminate test 650, and a terminate scan step 660. The trailer orientation display method 600 enables the operator to view a representation of the position of the trailer relative to the vehicle during the trailer docking process.

The initiate scan step 610 begins the process of scanning the area behind the vehicle. The graphical display 120 signals the scanning module 130 to begin the'trailer positioning scanning method 700. In one embodiment, the display method 600 and the initiate scan step 610 are conducted in response to an operator depressing the start control 370 depicted in FIG. 3.

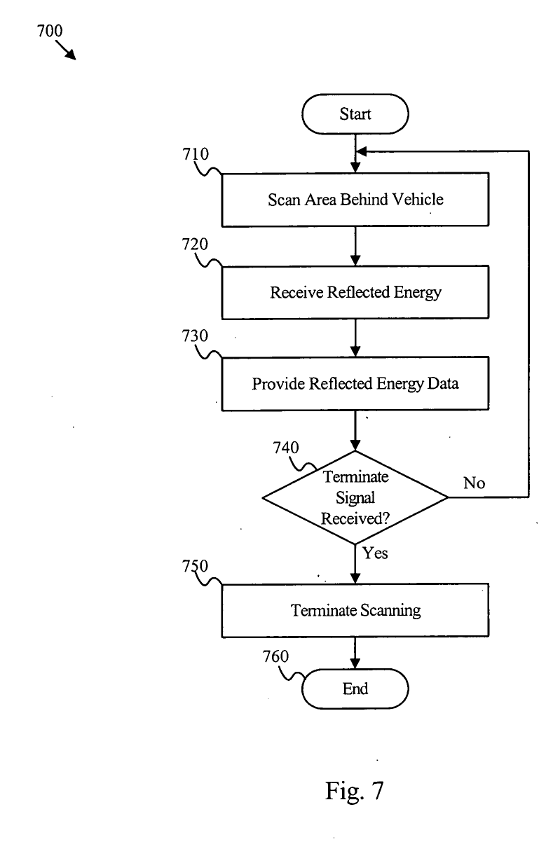

The receive data step 620 receives data from the scanning module 130. In one embodiment, the receive data step 620 is conducted in response to data transmitted in response to the completion of the trailer positioning scanning method 700 depicted in FIG. 7. In one embodiment, the received data is raw data that must be processed. In another embodiment, the received data is processed data ready for display on the graphical display 120.

The calculate position step 630 calculates the position of the trailer relative to the vehicle. In one embodiment, the calculate position step 630 is conducted by a processor associated with the display 120. In another embodiment, the calculate position step 630 is conducted by the scanning module 130 previous to the receive data step 620. In some embodiments, the calculate position step 630 converts between English and/or metric units according to the setting of the units control 360 of FIG. 3.

The display position step 640 displays the position of the trailer relative to the vehicle. Using the results of the calculate position step 630, the graphical display 120 displays the direction and distance to the trailer from the vehicle. The terminate test 650 determines whether the trailer orientation display method 600 should terminate or be repeated. In various embodiments, the trailer orientation display method 600 may be terminated by a signal initiated by a user control, by passage a period of time with no change in the relative positions of the vehicle and trailer, or by the absence of reflected energy received by the scanning module 130.

If the trailer orientation display method is not to be terminated, the method continues with the receive data step 620, otherwise the method proceeds to the terminate step 660. The terminate step 660 signals the scanning module 130 to discontinue emitting the energy wave or beam 140. The terminate step 660 may also shut off the graphical display 120. Upon completion of the terminate step 660, the trailer orientation display method 600 ends 670.

FIG. 7 is a flow chart diagram illustrating a trailer position scanning method 700 of the present invention. The trailer positioning scanning method 700 includes a scan area step 710, a receive energy step 720, a provide data step 730, a terminate test 740, and a terminate step 750. The trailer positioning scanning method 700 may be conducted in conjunction with the vehicle docking system 100 of FIG. 1. The trailer position scanning method may be initiated by the trailer orientation display method 600. The trailer position scanning method 700 facilitates the location of a trailer behind a vehicle.

The scan area step 710 initiates the process of scanning the area behind the vehicle with an energy wave or beam 140. The scan area step 710 continues until energy is received from the reflector. At the receive energy step 720, the scanning module 130 receives energy reflected by the reflector 160. The scanning module may measure the direction of the energy reflected by the reflector 160 and capture data to be provided to the graphical display 120.

The provide data step 730 transmits data from the scanning module 130 to the graphical display 120. The graphical display 120 uses the data in the trailer orientation display method 600. The terminate test 740 determines whether a signal has been received from the graphical display 120. If a signal has not been received, the trailer position scanning method 700 continues with the scan area step 710, otherwise it ends with the terminate step 750. The terminate step 750 shuts off the energy wave or beam 140. After the terminate step 750, the trailer position scanning method ends 760.

The present invention facilitates orienting a vehicle to a trailer. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for orienting a vehicle to a trailer, the apparatus comprising:
a scanning module configured to scan a region behind a vehicle;
a detector configured to receive energy reflected from a reflector affixed to a trailer; and
a graphical display configured to display to an operator within the vehicle a graphical depiction of a position of the trailer with respect to the vehicle.

2. The apparatus of claim 1, wherein the graphical depiction depicts an overhead view.

3. The apparatus of claim 1, wherein the graphical depiction comprises an icon representing a trailer hitch position.

4. The apparatus of claim 1, wherein the graphical display is further configured to display a graphical depiction of a relative trailer orientation.

5. The apparatus of claim 1, wherein the energy reflected from a reflector comprises energy selected from the group consisting of a laser energy, sonar energy, and microwave energy.

6. The apparatus of claim 1, wherein the scanning module is configured to scan with a substantially parallel energy beam.

7. The apparatus of claim 6, wherein the substantially parallel energy beam is intermittently emitted.

8. The apparatus of claim 6, wherein the substantially parallel energy beam occupies less than 4 degrees of arc.

9. The apparatus of claim 1, wherein the scanning module is further configured to measure a reflection distance.

10. The apparatus of claim 1, wherein the scanning module is further configured to detect a scanning angle in response to a reflected energy beam.

11. The apparatus of claim 1, wherein the graphical display is further configured to provide audible distance information.

12. The apparatus of claim 1, wherein the detector is further configured to receive energy reflected from a reflector configured to provide orientation information.

13. The apparatus of claim 1, wherein the detector is further configured to receive energy reflected from a reflector configured to provide payload description information.

14. The apparatus of claim 1, wherein the detector is further configured to detect a reflector pattern selected from the group consisting of a pattern of concentric circles, a diamond pattern, a checkerboard pattern, a bar code pattern, and a circular bar code pattern.

15. The apparatus of claim 1, wherein the scanning module is further configured to use a scanning pattern selected from the group consisting of a raster pattern, a circular spiral pattern, a box spiral pattern, and a zamboni pattern.

16. A method for orienting a vehicle to a trailer, the method comprising:
scanning a region behind a vehicle;
receiving energy reflected from a reflector affixed to a trailer; and
displaying to an operator within the vehicle a graphical depiction of a position of the trailer with respect to the vehicle.

17. The method of claim 16, further comprising displaying a graphical depiction of a relative trailer orientation.

18. The method of claim 16, further comprising measuring a reflection distance.

19. The method of claim 16, further comprising detecting a scanning angle in response to a reflected energy beam.

20. The method of claim 16, further comprising displaying information regarding orientation of the trailer.

21. The method of claim 16, wherein scanning is conducted with an intermittently emitted energy beam.

22. An apparatus for orienting a vehicle to a trailer, the apparatus comprising:
means for scanning a region behind;
means for receiving energy reflected from a reflector affixed to a trailer; and
means for displaying to an operator within the vehicle a graphical depiction of a position of the trailer with respect to the vehicle.

23. A system for orienting a vehicle to a trailer, the system comprising:
a vehicle configured to pull a trailer;
a trailer configured to attach to the vehicle;
a scanning module configured to scan a region behind a vehicle;
a detector configured to receive energy reflected from a reflector affixed to a trailer;
a reflector configured to reflect energy emitted from the scanning module; and
a graphical display configured to reside within a vehicle cab and visually display a graphical depiction of a position of the trailer with respect to a vehicle to an operator.

24. A computer readable storage medium comprising computer readable program code for orienting a vehicle to a trailer, the program code configured to conduct a method comprising:
receiving data from the scanning module into a buffer;
calculating the relative position of the trailer; and
displaying to an operator within the vehicle a graphical depiction of a relative position of the trailer with respect to the vehicle.
